(19) United States
(12) Patent Application Publication
(10) Pub. No.: US 2015/0161699 A1
(43) Pub. Date: Jun. 11, 2015

(54) APPARATUS AND METHOD FOR PROVIDING AN ONLINE TRADING SERVICE

(71) Applicant: Electronics and Telecommunications Research Institute, Daejeon (KR)

(72) Inventor: Su Min JANG, Daejeon (KR)

(73) Assignee: Electronics and Telecommunications Research Institute, Daejeon (KR)

(21) Appl. No.: 14/331,860

(22) Filed: Jul. 15, 2014

(30) Foreign Application Priority Data
Dec. 10, 2013 (KR) 10-2013-0152994

(51) Int. Cl. G06Q 30/06

(52) U.S. Cl. CPC G06Q 30/0613

(57) ABSTRACT

The embodiment of the present invention relates an apparatus and method for providing an online trading service. The online trading apparatus enables a seller to select buyers suitable to the desired condition and suggests a sales condition to the selected buyers to achieve transaction by grouping purchasing information based on query information of the seller and providing the grouped purchasing information to the seller.

### CROSS-REFERENCE TO RELATED APPLICATION

The priority of Korean patent application No. 10-2013-0152994 filed on 10 Dec. 2013, the disclosure of which is hereby incorporated by reference in its entirety, is claimed.

### BACKGROUND

The present invention relates an apparatus and method for providing an online trading service, and more particularly, an apparatus and method for more conveniently selecting buyers suitable to the desired condition of a seller by grouping purchasing information based on query information of the seller and providing the grouped purchasing information to the seller, and suggesting the sales condition to the selected buyers to achieve transaction.

Generally, in order purchase the best product with the lowest cost, a buyer visits a store or makes a call and then inquires sales conditions and drives a bargain. However, practically, it is impossible that a consumer visits all stores or makes a call to check a sale condition, and also a seller have a limit to inform buyers of sales conditions widely.

Accordingly, E-commerce systems are established for trading products through the Internet, and various trading methods are suggested for activating a trade.

A conventional trading (dealing) method using Internet is that a buyer searches an online site or communal purchase site, identifies whether the desired product is sold or not at the sites, and purchases a product while comparing the sale prices. However, the conventional trading method is more complicated and uncomfortable except not visiting a store directly.

In the position of sellers, there is a problem, that they should decide a price of the product while they can't know the sales amount of the product. Also, since sellers can't predict where and how many sales products should be delivered, they can't predict delivery costs affecting the price of the product.

### PRIOR ART

[Patent Document] U.S. Pat. No. 8,150,730

### [Patent Document] KR 2011-0022518

### SUMMARY

The embodiment of the present invention enables a buyer to more conveniently purchase a product and enables a seller to select buyers suitable to the desired condition of a seller to sell a product, thereby providing profits to both a seller and a buyer.

An online trading apparatus according to an embodiment of the present invention may comprise a purchasing information collector for collecting information of purchasing information and storing them in a database, when a purchasing request information is received from a buyer terminal; a purchasing information searcher for searching the purchasing information corresponding to query information in the database, when the query information is received from a seller terminal or a buyer terminal; a purchasing information display for making grouped data using the purchasing information searched by the purchasing information searcher and displaying the grouped data on the seller terminal or the buyer terminal; and a controller for transmitting a sales condition received from the seller terminal to a buyer terminal, and transmitting a purchasing decision received from the buyer terminal to the seller terminal.

A method of online trading apparatus according to an embodiment of the present invention may comprise: receiving purchasing request information including information for a purchasing items from a buyer terminal and storing it in a database; providing a seller terminal or the buyer terminal with a searching interface for searching purchasing information; searching the purchasing information corresponding to a query information in the database, when the query information is received from the seller terminal or the buyer terminal through the searching interface; grouping the searched purchasing information based on the purchasing item and displaying the grouped purchasing information on the seller terminal or the buyer terminal; receiving information for a purchasing subject selected by the grouped purchasing information and a sales condition from the seller terminal; transmitting the sales condition to the buyer terminal and receiving information for a purchasing decision from the terminal of the purchasing subject; and transmitting the information for the purchasing decision to the seller terminal.

### BRIEF DESCRIPTION OF THE DRAWINGS

FIG. 1 is a block diagram schematically showing an entire system configuration using the online trading apparatus according to an embodiment of the present invention.

FIG. 2 is a block diagram more in detail showing the online market server in FIG. 1.

FIG. 3 is a diagram illustrating purchasing items of the purchasing request list according to an embodiment of the present invention.

FIG. 4 is a diagram more in detail illustrating a process of collecting purchasing information from a buyer terminal in FIG. 1.

FIG. 5 is a diagram more in detail showing a view provided with query information from a seller terminal in FIG. 1.

FIG. 6 is a diagram for explaining an online trading service providing method.

FIG. 7 is diagram as an example showing the searching result that a product identification key (K330001) corresponding to a car is input in a “PRODUCT INFORMATION” item and 2014.1.31 is input in a “DELIVERY TERM” item as a query item.

FIG. 8 is diagram as an example showing the searching result that a product identification key (K330001) corresponding to a car is input in a “PRODUCT INFORMATION” item and the whole country is set in a “DELIVERY TERM” item as a query item.

FIG. 9 is diagram as an example showing the searching result that the whole country is set in a “DELIVERY PLACE” item and more than 100 are set in a “PURCHASING AMOUNT” item as a query item.

FIG. 10 is diagram as an example showing the searching result that a product identification key (K330001) corresponding to a car is input in a “PRODUCT INFORMATION” item and Daejeon is set in a “DELIVERY PLACE” item as a query item.

### DESCRIPTION OF EMBODIMENTS

Hereinafter, preferred embodiments of the present invention will be described below in more detail with reference to the accompanying drawings. The terms used in the following description and claims are not limited to their dictionary meanings, but, are merely used to enable a clear and consistent understanding of the invention. Accordingly, it should be apparent to those skilled in the art that the following description of embodiments of the present invention is provided for illustration purpose only and not for the purpose of limiting the invention as defined by the appended claims and their equivalents. Therefore, embodiments and drawings described herein are simply exemplary and not exhaustive, and it will be understood that various modifications and equivalents may be made to take the place of the embodiments.

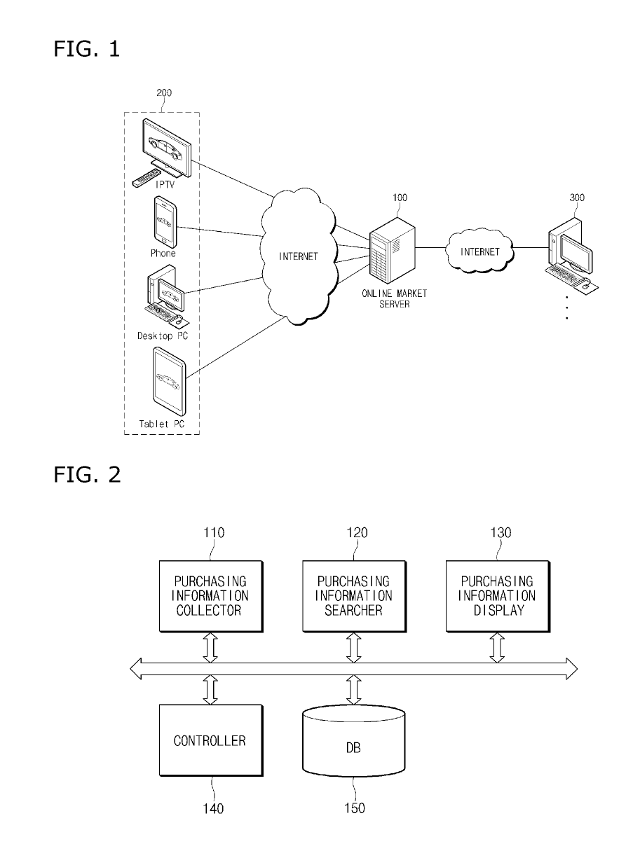

FIG. 1 is a block diagram schematically showing an entire system configuration using the online trading apparatus according to the embodiment of the present invention.

The online trading system shown in FIG. 1 may include an online market server 100, buyer terminals 200 and a seller terminal 300.

The online market server 100 is a computer system supporting online trade between buyers and a seller by performing data communication with the buyer terminals 200 and a seller terminal 300 through a network. The online market server 100 provides the buyer terminals 200 with information for a sales product and enables the buyer to identify this. When the online market server 100 receives purchasing request information from the buyer terminals 200, the online market server 100 collects and stores it as purchasing information. The purchasing request information is information for the product which a buyer wants to purchase. The purchasing request information can be provided as a purchasing request list. The purchasing request list includes data input by a buyer for the purchasing items such as product information (product identification key, product group), purchase quantity, purchase price, delivery term and delivery place, etc. The online market server 100 provides user interface (searching interface) to the seller terminal 300. The seller can search the purchasing information and select buyers (purchasing subject) suitable to the desired condition of himself using the searching interface. In other words, When the online market server 100 receives query information of the seller from the seller terminal 300 through the searching interface, it enables the seller to select purchasing subject in the buyers satisfying an query condition of the seller by processing (classifying and grouping) information of the purchasing request lists collected from the buyer terminals 200 to fit the query of the seller and by providing the processed information to the seller terminal 300. Also, when the online market server 100 receives information for a sales condition from the seller terminal 300, it transmits the information to the terminals 200 of the purchasing subject. And then, when the online market server 100 receives purchasing decisions for the sales condition from the terminals 200 of the purchasing subject, it collects the purchasing decisions and transmits a combined purchasing decision result to the seller terminal 300. The online market server 100 also can provide the searching interface to the buyer terminals 200 so that the buyer searches the purchasing information and checks a purchasing situation. Hereby, the online market server 100 enables the buyer to compare his purchasing situation with other buyers' purchasing situation.

The buyer terminals 200 are terminals of buyers to want to purchase products through the online market server 100. The buyer terminals 200 may include wired/wireless terminals capable of transmitting and receiving data with the online market server 100 through a wired/wireless network. For example, the buyer terminals 200 may include IP TVs, portable communication terminals such as a smart phone or a tablet PC, and various types of wired/wireless terminals such as PC, etc.

The seller terminal 300 is a terminal of seller to want to sell products through the online market server 100. The seller terminal 300 may include wired/wireless terminals capable of transmitting and receiving data with the online market server 100 through a wired/wireless network. In FIG. 1, only single terminal is shown as the seller terminal 300, but the seller terminal 300 may include various types of wired/wireless terminals such as the buyer terminal.

FIG. 2 is a block diagram more in detail showing the online market server in FIG. 1.

The online market server 100 may include a purchasing information collector 110, a purchasing information searcher 120, a purchasing information display 130, controller 140 and a database 150.

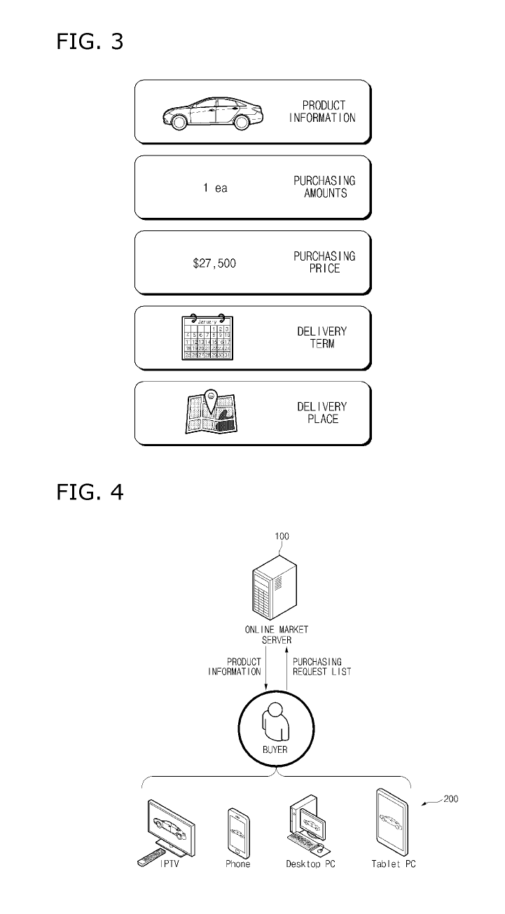

If the purchasing information collector 110 receives purchasing request lists including data (specific value) input by a buyer for a plurality of purchasing items from the buyer terminals 200, it collects purchasing information by classifying information included in the purchasing request lists based on each purchasing item and storing it in the database 150. FIG. 3 is a diagram illustrating purchasing items of the purchasing request list according to an embodiment of the present invention. When the purchasing information collector 110 receives purchasing request list as shown in FIG. 3 from the buyer terminals 200, it matches the information for the buyer making the corresponding purchasing request list and the information for the purchasing items (product information, purchase quantity, purchase price, delivery term and delivery place) included in the corresponding purchasing request list and stores the matching information in the database 150.

The purchasing information searcher 120 provides the seller terminal 300 with the searching interface capable of searching the purchasing information stored in the database 150. When the purchasing information searcher 120 receives query information from a seller through the searching interface, it searches the purchasing information corresponding to the query in the database 150 and transfers the searched information to the purchasing information display 130. The searching interface is a seller interface (GUI) capable of searching the purchasing information by inputting data (specific value) to some items of purchasing items included in the purchasing request list. The query information is the information input by the seller to at least one item of items (items same as the items included in the purchasing request list) displayed on the searching interface. The seller can input data into input boxes of the searching interface by directly inputting a desired value, or by selecting one of the values displayed on the searching interface when the seller clicks the input box. When the purchasing information searcher 120 receives the value for a specific item (a query item) of items included in the purchasing request list from the seller terminal 300, it searches the information corresponding to the value of the query item in the purchasing information stored in the database 150, and transfers the searching result to the purchasing information display 130. The purchasing information searcher 120 also can provide the searching interface to the buyer terminals 200. When the purchasing information searcher 120 receives the query information from a buyer, likewise, it searches the purchasing information corresponding to the query in the database 150 and transfers the searching result to purchasing information display 130.

The purchasing information display 130 processes (classifies) and groups the purchasing information searched by the purchasing information searcher 120, and displays the grouped information on the seller terminal 300 or the buyer terminals 200. For example, the purchasing information display 130 may classify the purchasing information searched by the purchasing information searcher 120 based on the detail value of items except the query item (the item except the items included in the purchasing request list), and group same values as a same group. This grouping method by the purchasing information display 130 will be described below in detail.

The controller 140 controls the operation of the online market server 100 and controls transmitting and receiving data with the buyer terminals 200 and the seller terminal 300. When the controller 140 receives purchasing subject selection information and the information for a sales condition from the seller terminal 300, it searches the information for the purchasing subject in the database 150 and transfers the sales condition to the buyer terminals 200 corresponding to the purchasing subject. Also, when the controller 140 receives the information for a purchasing decision from the buyer terminals 200 receiving the sales condition, it collects information for the purchasing subject deciding a purchase and transfer the collected information (a combined purchasing decision result) to the seller terminal 300.

The database 150 stores the information for the buyer and seller having an account for the online market server 100, the information for the products registered in the online market server 100 for online trading, and the purchasing information collected from the purchasing request lists of the buyer terminal 200.

FIG. 4 is a diagram more in detail illustrating a process of collecting purchasing information from a buyer terminal in FIG. 1.

The buyer accesses the online market server 100 using the buyer terminal 200 and receives the product information for the products registered in the online market server 100 by sellers. At this time, the method for receiving the product information may include watching the product information displayed on a home shopping channel or a general broadcasting channel of an IPTV, or searching the product information using a personal computer (PC) by accessing a website operated by the online server 100. Also, the buyer can get the product information by accessing the online market server 100 using an online trading APP installed in a smart phone or tablet PC.

When the buyer receiving the product information wants to purchase a product, he or she makes a purchasing request list shown in FIG. 3 and transmits it to the online market server 100. For example, if a buyer finds a desired product on a home shopping channel or a general broadcasting channel and clicks a particular button, the online market server 100 recognizes this and displays a form capable of making a purchasing request list on TV screen, so enable the buyer to input a desired value in a desired item of the form using a remote control. Also, if the buyer selects a particular menu (for example, a purchasing request menu) in an internet site (for example, website) operated by the online market server 100, the online market server 100 may display a web page capable of making a purchasing request list on a screen of the buyer terminal 200. In FIG. 3, the product information may include a product identification key.

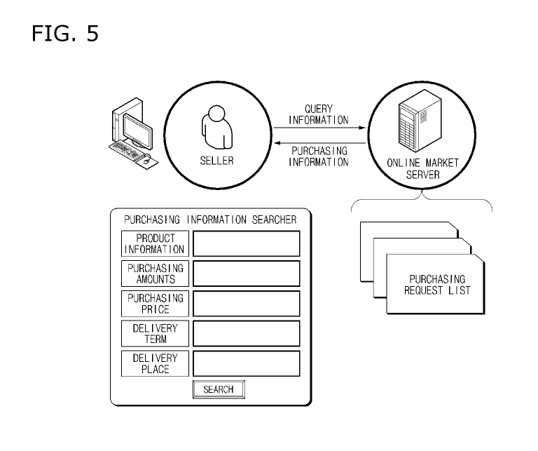

FIG. 5 is a diagram more in detail showing a view provided with query information from the seller terminal in FIG. 1.

The searching interface includes items included in the purchasing request list as shown in FIG. 5. When a seller clicks a “SEARCH” button after inputting a desired value to a desired item (query item) of the searching interface displayed on a screen of the seller terminal 300, the seller terminal 300 transmits the query information to the online market server 100. The query information includes information input through the searching interface. Accordingly, the online market server 100 searches the purchasing information corresponding to the query item received from the seller terminal 300 in the purchasing information collected from the purchasing request list. And then, the online market server 100 classifies and groups the searched purchasing information on the basis of items except the query items, and transfers the grouped information to the seller terminal 300. Although FIG. 5 is described on the basis of a seller, the online market server 100 can get the query information from a buyer in same manner.

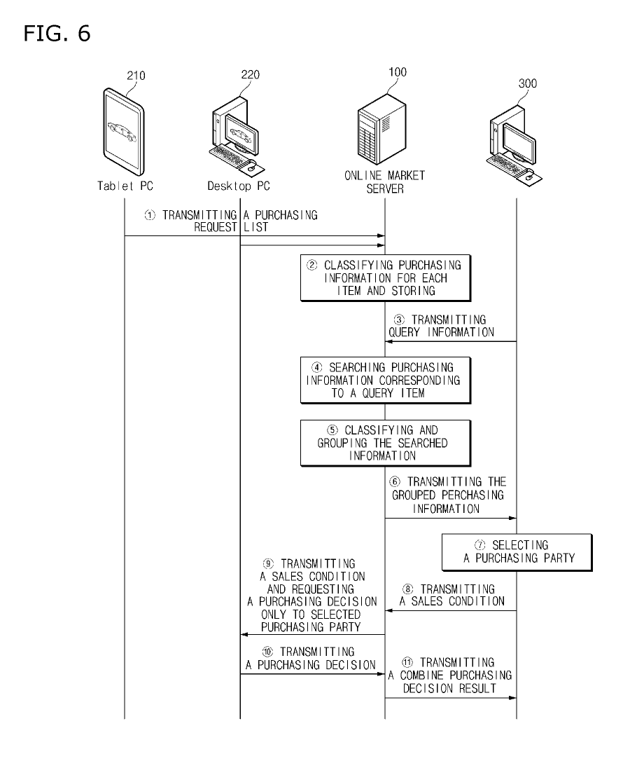

FIG. 6 is a diagram for explaining an online trading service providing method.

The buyers generate a buyer account by providing the buyer information such as personal information to the online market server 100. The seller generates a seller account by providing the seller information such as a company name and an address, etc. to the online market server 100.

The Buyers access the online market server 100 through the buyer terminal 210, 220, receive product information for the products registered in the online market server 100, and search whether a desired product exists or not. The buyer terminal 210, 220 includes various terminals, which are capable of wired/wireless communication with the online market server 100. If the buyers find the product to want to purchase, they make the purchasing request list using the buyer terminal 210, 220 as shown in FIG. 3 and transmit the list to the online market server 100 (\textcircled{1}).

The purchasing request list includes product information, purchasing quantity, purchase price, delivery term and delivery place. The delivery place can be an address of a buyer or other place which a buyer wants, and it can be input as a unit of an administrative district, not an exact address. The product information includes a product identification key for discriminating products and product group information (for example, computer/peripheral/keyboard, etc.) in which the product is included. The buyer can omit a part of items with not inputting when generating a purchasing request list.

When the online market server 100 receives purchasing request lists from the buyer terminal 210, 220, the purchasing information collector 110 of the online market server 100 classifies information included in the purchasing request lists for each item, matches it with information for the corresponding buyer, and stores them in the database 150 (\textcircled{2}).

When the seller clicks a “SEARCH” button after inputting a desired value to a desired item of the searching interface displayed on a screen, the seller terminal 300 transmits the corresponding query information to the online market server 100 (\textcircled{3}).

When the online market server 100 receives the query information from the seller terminal 300, the purchasing information searcher 100 of the online market server 100 searches the purchasing information corresponding to the query item in the database 150 and transfers the searching result to the searching information display 130 (\textcircled{4}).

For example, if a seller inputs a product identification key (K330001) corresponding to a car in a “PRODUCT INFORMATION” item and inputs 2014.01.31 in a “DELIVER TERM” item, the purchasing information searcher 120 searches the purchasing information stored in the database 150 whether information to want to deliver a car until 2014.1.31 exists or not. If the information matching the condition of query items exists, the purchasing information searcher 120 transfers the information for the items (display items) except the query items, that is, purchasing quantity, purchase price and delivery place in information corresponding to the condition of query items to the purchasing information display 130.

The purchasing information display 130 classifies and groups the purchasing information provided from the purchasing information searcher 120 based on the detailed value of the purchasing item, and provides the grouped purchasing information to the seller terminal 300 so that it is displayed on a screen of the seller terminal 300 (\textcircled{5},\textcircled{6}).

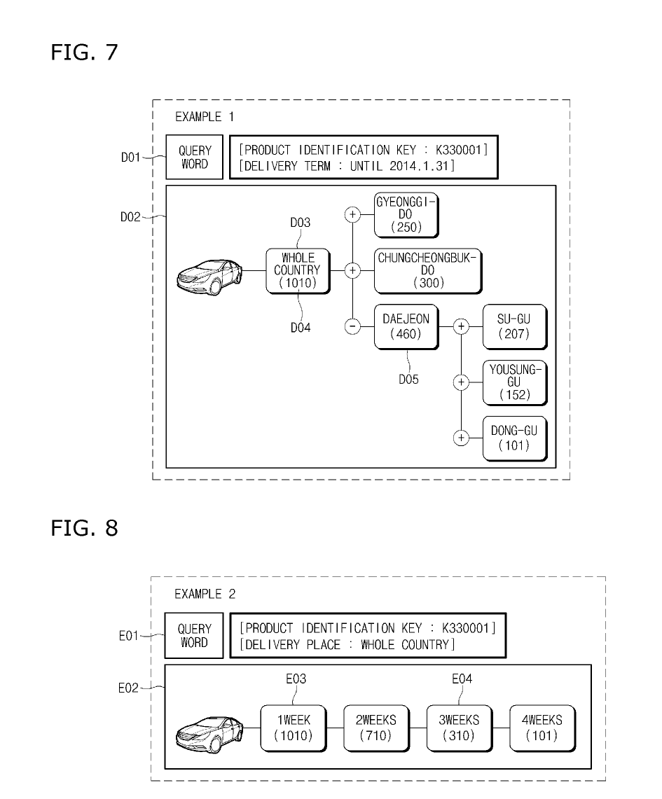

FIGS. 7 to 10 are diagrams as an example grouping purchasing information and displaying it.

FIG. 7 is diagram as an example showing the searching result that a product identification key (K330001) corresponding to a car is input in a “PRODUCT INFORMATION” item and 2014.1.31 is input in a “DELIVERY TERM” item as a query item.

The purchasing information display 130 displays the contents queried by the seller on query word window (D01). And, the purchasing information display 130 classifies the purchasing information based on each region (administrative district) using the information for the delivery place of the display items, groups them into same region, and displays the grouped result on a display window (D02) as shown in FIG. 7. At this time, the purchasing information display 130 displays the grouped purchasing amount for each region on the corresponding region display box together. FIG. 7 shows that the number of the car purchasing amount, which want to deliver until 2014.01.31, is 250 units in Gyeonggi-do, 300 units in Chungcheongbuk-do and 400 units in Daejeon, and there is no one in other region. At this time, the region box (D03) displayed as a “the whole country” combines the entire region, and the number of the overall car purchasing amount matching the condition of the query items are 1010(250+300+450).

If the region displayed in a region display box is a large region (for example, state, county) and includes medium/small regions (for example, county, city, town), the purchasing information display 130 displays ⊕ sign in front of the regional display box. If ⊕ sign is clicked, the purchasing information display 130 may display sub-region display boxes corresponding to the medium/small regions. In FIG. 7, when the ⊕ sign in front of the regional display box (D05) is clicked, three sub-region display boxes (SU-GU, YOUSUNG-GU, DONG-GU) are displayed. Each sub-region display box includes a number of cars corresponding to the medium/small regions. If the sub-region display boxes are displayed, ⊕ sign is changed to ⊖ sign.

FIG. 8 is diagram as an example showing the searching result that a product identification key (K330001) corresponding to a car is input in a “PRODUCT INFORMATION” item and the whole country is set in a “DELIVERY TERM” item as a query item.

The purchasing information display 130 displays the contents queried by the seller on query word window (E01). And, the purchasing information display 130 classifies the purchasing information based on each detailed term using the information for the delivery term of the display items, groups them into same term, and displays it on a display window (E02) as shown in FIG. 8. At this time, the purchasing display 130 displays the grouped purchasing amount for each term on the corresponding term display box (E03, E04) together. In other words, FIG. 8 shows that the number of the car purchasing amount, which have to be delivered within 1 week, 2 weeks, 3 weeks, 4 weeks, are 1010 units, 710 units, 310 units and 101 units on a national scale.

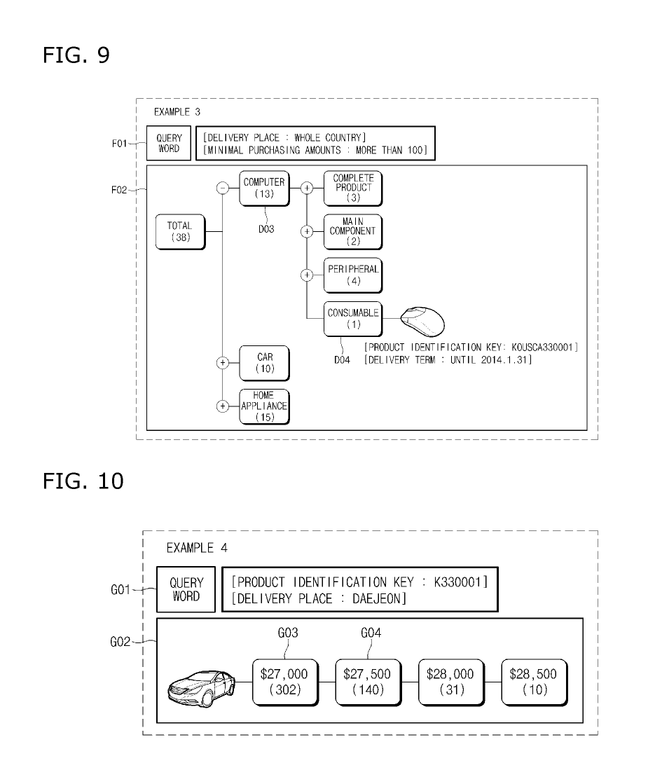

FIG. 9 is diagram as an example showing the searching result that the whole country is set in a “DELIVERY PLACE” item and more than 100 are set in a “PURCHASING AMOUNT” item as a query item.

The purchasing information display 130, likewise, displays the contents queried by the seller on query world window (F01). And, the purchasing information display 130 classifies the purchasing information based on each detailed product group using the product information of the display items, groups them into same product group, and displays it on a display window (F02) as shown in FIG. 9. At this time, the purchasing display 130 displays the grouped purchasing amount for each product group on the corresponding product display box (F03, F04) together.

In common with FIG. 7, if the product group includes sub-product group, the purchasing information display 130 displays ⊕ in front of the product display box. If the sub-product groups are displayed, ⊕ sign is changed to ⊖ sign.

FIG. 10 is diagram as an example showing the searching result that a product identification key (K330001) corresponding to a car is input in a “PRODUCT INFORMATION” item and Daejeon is set in a “DELIVERY PLACE” item as a query item. In other words, in FIG. 8, the delivery place is set as the whole country and grouped for each city, but in FIG. 10, the delivery place is set as a specific region.

The purchasing information display 130 displays the contents queried by the seller on query word window (G01). And, the purchasing information display 130 classifies the purchasing information based on each price using information for each purchase price of cars to be delivered to Daejeon in the information for the delivery place of the display items, groups them into same price, and displays it on a display window (G02) as shown in FIG. 10.

At this time, the purchasing display 130 displays the grouped purchasing amount for each price on the corresponding price display box (G03, G04) together.

As the above described embodiments, when a product information is grouped and displayed, method for selecting information as a first classification standard may be determined in accordance with a predetermined algorithm automatically or be determined by the seller arbitrarily, as illustrated in FIGS. 7 to 10.

The seller searches a product information using a method illustrated in FIGS. 7 to 10, and then selects a particular buyer group suitable to a desired condition to decide the purchasing subject (\textcircled{7}).

For example, in FIG. 8, the seller can select the buyers requesting a delivery within 2 weeks as the purchasing subject by clicking the product display box for “2 weeks”.

The seller selecting the purchasing subject transfers the sales condition to be suggested to the purchasing subject to the online market server 100 through the seller terminal 300 (\textcircled{8}).

The seller can suggest a condition, for example, that I would additionally provide other product or service if you buy my product, as a sales condition. Also, if it is predicted there are so many competitor for sales, the seller can suggest a condition, that I would discount the purchase price which the purchasing subject writes in the purchasing request list, as a sales condition. Since the sales conditions are freely decided by the seller, various sales conditions can be suggested. Of course, the seller can select the purchasing subject without suggesting a additional sale condition.

When the controller 140 of the online market server 100 receives information for the purchasing subject and sales condition from a seller terminal, it searches contact information (for example, e-mail) for the purchasing subject in the database 150. And then, the controller 140 provides the sales condition of the seller to the purchasing subject and transmits purchase request, which inquires whether you buy a product according to the sales condition, to the purchasing subject (\textcircled{9}).

When the purchasing subject decides whether or not to buy, the buyer terminal 220 transmits the information for a purchasing decision to the online market server 100 (\textcircled{10}).

When the controller 140 of the online market server 100 receives the information for the purchasing decision from the buyer terminals of the purchasing subject, it transfer a combined purchasing decision result (a final purchasing decision information) and the information for the purchasing subject (for example, contact and address information) to the seller terminal 300 (\textcircled{11}).

The seller delivers the product to the purchasing subject using the information transferred by the online market server 100 according to the schedule.

In the method described in FIG. 5, the processes of the steps \textcircled{3}˜\textcircled{6} can be applied to the buyer. In other words, the buyer also transmits query information to the online market server 100 using the searching interface of the buyer terminal 200 and the buyer can get the grouped purchasing information and monitor the purchasing situation.

The above embodiments of the present invention are illustrative and not limitative. Various alternatives and equivalents are possible. The invention is not limited by the type of deposition, etching polishing, and patterning steps described herein. Nor is the invention limited to any specific type of semiconductor device. For example, the present invention may be implemented in a volatile memory device or non-volatile memory device. Other additions, subtractions, or modifications are obvious in view of the present disclosure and are intended to fall within the scope of the appended claims.

What is claimed is:

1. An online trading apparatus comprising:
a purchasing information collector for collecting information of purchasing information and storing them in a database, when a purchasing request information is received from a buyer terminal;
a purchasing information searcher for searching the purchasing information corresponding to query information in the database, when the query information is received from a seller terminal or a buyer terminal;
a purchasing information display for making grouped data using the purchasing information searched by the purchasing information searcher and displaying the grouped data on the seller terminal or the buyer terminal; and
a controller for transmitting a sales condition received from the seller terminal to a buyer terminal, and transmitting a purchasing decision received from the buyer terminal to the seller terminal.

2. An online trading apparatus according to claim 1, wherein the purchasing information collector receives a purchasing request list that includes the purchasing request information of buyer entered data on a plurality of purchasing items.

3. An online trading apparatus according to claim 2, wherein the purchasing information collector receives the purchasing request list that includes at least one of a product information, purchasing amounts, a purchase price, a delivery term and a delivery place as user entered data.

4. An online trading apparatus according to claim 2, wherein the purchasing information searcher provides a user interface of the seller terminal or buyer terminal, wherein the user interface enables the searcher to input the query information by selecting at least one of the purchasing items.

5. An online trading apparatus according to claim 4, wherein the purchasing information searcher searches the purchasing information corresponding to a value of the query item, and transfers information for the items (display items) except the query item in the searched purchasing information to the purchasing display.

6. An online trading apparatus of claim 5, wherein the purchasing information display makes the grouped data of the purchasing information based on information for a specific item of the display items and displays it.

7. An online trading apparatus according to claim 6, wherein the purchasing information display classifies the purchasing information into the specific items or ranged value and makes the grouped data with the classified data.

8. An online trading apparatus according to claim 6, wherein the purchasing information display displays the information for the item except the specific item of the display items together with the information for the specific item.

9. An online trading apparatus according to claim 1, wherein the controller transfers information for the purchasing subject together with information for the purchasing decision to the seller terminal.

10. An online trading method performed by a computer apparatus on online, the method comprising the steps of:
receiving purchasing request information including information for a purchasing items from a buyer terminal and storing it in a database;
providing a seller terminal or the buyer terminal with a searching interface for searching purchasing information;
searching the purchasing information corresponding to a query information in the database, when the query information is received from the seller terminal or the buyer terminal through the searching interface;
grouping the searched purchasing information based on the purchasing item and displaying the grouped purchasing information on the seller terminal or the buyer terminal;
receiving information for a purchasing subject selected by the grouped purchasing information and a sales condition from the seller terminal;
transmitting the sales condition to the buyer terminal and receiving information for a purchasing decision from the terminal of the purchasing subject; and
transmitting the information for the purchasing decision to the seller terminal.

11. An online trading method according to claim 10, wherein the receiving purchasing request information includes:
receiving a purchasing request list including data input by the buyer for a plurality of the purchasing items.

12. An online trading method according to claim 11, wherein the providing a searching interface includes:
displaying a user interface enabling a seller to select at least one item of the purchasing items included in the purchasing request list as a query item on the seller terminal.

13. An online trading method according to claim 12, wherein the searching the purchasing information corresponding to query information includes:
searching information for items except the query item (display item) in the purchasing information corresponding to a value of the query item.

14. An online trading method according to claim 13, wherein the grouping the searched purchasing information includes:
grouping the searched purchasing information based on information for a specific item of the display items.

15. An online trading method according to claim 14, wherein the grouping the searched purchasing information includes:
classifying the searched purchasing information based on a detailed value of the specific item and grouping same values as a same group.

16. An online trading method according to claim 14, wherein the displaying the grouped purchasing information on the seller terminal includes:
displaying information for the item except the specific item of the display items together with the information for the specific item.
